(19) United States
(12) Patent Application Publication
(10) Pub. No.: US 2002/0054126 A1
(43) Pub. Date: May 9, 2002

(54) BROWSER TRANSLATION BETWEEN FRAMES AND NO FRAMES

(76) Inventor: OWEN JOHN GAMON, ROCHESTER, MN (US)

Correspondence Address: OWEN J GAMON, IBM CORPORATION DEPT 917, 3605 HIGHWAY 52 NORTH, ROCHESTER, MN, 559017829

(21) Appl. No.: 09/174,146

(22) Filed: Oct. 16, 1998

(51) Int. Cl. G06F 3/00

(52) U.S. Cl. 345/781

(57) ABSTRACT

A browser has a frames/no frames option. The browser dynamically transforms a page with frames into a page without frames by rewriting the control-tags in the page. The transformation process is reversible, so the browser can also transform a page without frames into a page with frames. In this way, the user can control whether displayed pages are shown with frames instead of the web-page designer being in control.

### FIELD OF THE INVENTION

The present invention relates in general to improved information processing systems. In particular, the present invention relates to a method and system for frame translation in a browser.

### BACKGROUND

The development of distributed, computer networks, such as the Internet, allows users to retrieve vast amounts of electronic information previously unavailable. The Internet increasingly is displacing more conventional means of information transmission, such as newspapers, magazines, and even television.

Electronic information transferred between computer networks (e.g., the Internet) can be presented to a user in hypertext, a metaphor for presenting information in a manner in which text, images, sounds, and actions become linked together in a complex, non-sequential web of associations that permit the user to “browse” through related topics, regardless of the presented order of the topics. For example, traveling among links to the word “iron” in an article might lead the user to the periodic table of the chemical elements (i.e., linked by the word “iron”), or to a reference to the use of iron in weapons in Europe in the Dark Ages. The term “hypertext” is used to describe documents, as presented by a computer, that express the nonlinear structure of ideas, as opposed to the linear format of books, film, and speech. The combination of hypertext documents connected by their links in the Internet is referred to as the World Wide Web (WWW).

Networked computers utilizing hypertext conventions typically follow a client/server architecture. A “client” is usually a computer that requests a service provided by another computer (i.e., a server). A “server” is typically a remote computer system accessible over the network. Based upon such requests by the user at the client, the server presents information to the user as responses to the client. The client typically contains a program, called a browser, that communicates the requests to the server and formats the responses for viewing (browsing) at the client. The browser retrieves a web page from the server and displays it to the user at the client.

A “web page” (also referred to as a “page”) is a data file, or document, written in a hyper-text language that can have hyperlinks, text, graphic images, and even multimedia objects, such as sound recordings or video clips, associated with that data file. The browser reads the contents of the document, which includes control tags and data, and interprets the control tags in order to format the data in the displayed web page.

Some browsers contain a function that allows the simultaneous display of multiple “frames” within a single window. A frame within a computer-display window is analogous to a pane of glass within a building window. The web-page document can contain frame control-tags that specify the size, shape, and contents of the frame. The browser reads the document and formats the frames within the page according to these frame control-tags.

Frames are not child windows; that is, they are not necessarily resizable by the user since their size and shape are fixed by the frame control-tags in the document. This characteristic of frames can be very frustrating for the user because one or more frames can consume so much of the display area that other frames are difficult to see. For example, a first frame might provide control buttons or hypertext links to other web pages, a second frame might contain advertisements, leaving only a third frame to contain the information that is of actual interest to the user. As a result, the viewable area assigned to third frame might be quite small. This small size can make the content difficult to read and also make it difficult to scroll through the frame using the scroll button because a small control motion moves the contents very fast in comparison to the frame size. These difficulties are exacerbated when the parent browser-window uses less than the full display window (e.g., the browser is in a restored state). Additionally, the advertisement in second frame might be presented with automated blinking, scrolling, or highlighting, which is very distracting and can be particularly aggravating if the frame cannot be removed or reduced in size. Thus, a frustrated user might compare using frames to reading “War and Peace” engraved on the head of a pin with a magnifying glass while a neon light blinks in the background.

Older web browsers do not support frames, so some web sites give the user an option of downloading two pages that are generally similar except that one page uses frames and the other does not (two different hypertext links are provided to the alternative pages). This option allows the user to avoid the aforementioned problems with frames, but not all web sites provide this option. Furthermore this approach results in a user losing any advantages of frames that might be desirable. For example, the user might want to keep the set of links in the first frame available while loading other pages in the third frame.

In light of the foregoing problems, it is desirable to devise an improved web browser providing an alternative mechanism for handling page frames, to allow the user to exert more control over browsing web pages.

### SUMMARY OF THE INVENTION

The invention is a method and system for browsing a displayable page. In the preferred embodiment, a browser has a frames/no frames option. The browser dynamically transforms a page with frames into a page without frames by rewriting the control-tags in the page. The transformation process is reversible, so the browser can also transform a page without frames into a page with frames. In this way, the user can control whether displayed pages are shown with frames instead of the web-page designer being in control.

### BRIEF DESCRIPTION OF THE DRAWINGS

FIG. 1 is an elevation view of a computer display showing a conventional, graphical user-interface providing a parent window with several child windows, each of which employs scroll bars to pan a document with the respective window.

FIG. 2 is a pictorial representation of a conventional computer-network, including interconnected servers and client workstations.

FIG. 3 is an elevation view of a computer display, showing a conventional web-browser, which presents multiple files in different frames of a single web page.

FIG. 4 is a pictorial representation of a computer system that can be utilized to implement a preferred embodiment.

FIG. 5 is a block diagram of a representative hardware environment of the processing unit of the computer system illustrated in FIG. 4.

FIG. 6 is a block diagram of software stored within the memory of the computer system depicted in FIG. 4.

FIGS. 7, 8, and 9 are pictorial representations of the interfaces that a user can operate to control the operation of a preferred embodiment.

FIG. 10 shows a pictorial representation of an example operation of the preferred embodiment.

FIG. 11 is a pictorial representation of example contents of a web-page document, according to the preferred embodiment.

FIGS. 12 and 13 are flowcharts that describe the operation of the preferred embodiment.

### DESCRIPTION OF THE PREFERRED EMBODIMENT

Technology Overview

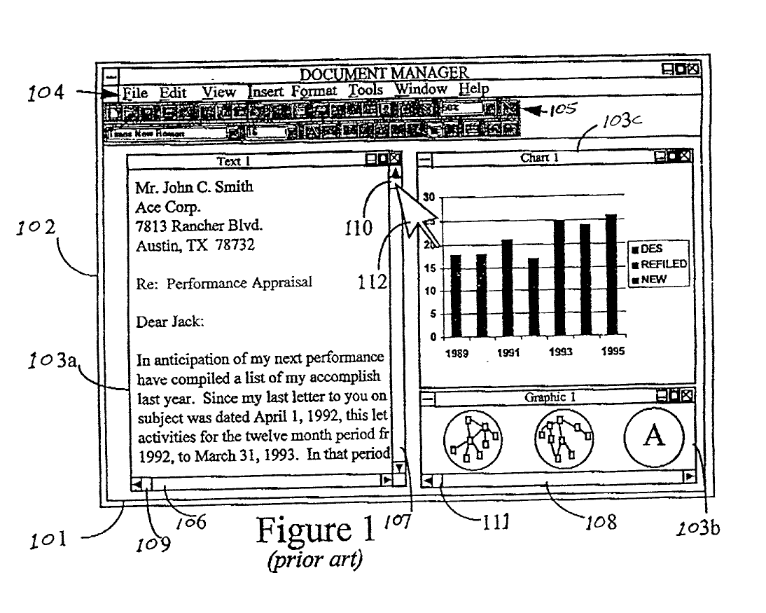

As illustrated in FIG. 1, conventional computers often use a graphical user-interface (GUI) to present information to the user. The GUI is provided by software that is loaded on the computer, specifically the computer's operating system acting in conjunction with application programs. In example of FIG. 1, primary application-window (“parent” window) 101 is presented on display device (i.e., video monitor) 102. The application window includes several secondary windows (“child” windows) 103a, 103b, and 103c, which are enclosed by parent window 101. “Sibling” windows 103a, 103b, and 103c depict the contents of various files or documents. A standard set of menu commands 104 and tool bar 105 can be provided as part of the GUI, to simplify manipulation and control of the objects (e.g., text, charts, and graphics) within the child windows. While FIG. 1 illustrates the sibling windows arranged side-by-side, they can also overlook one another, in multiple layers.

A given file can be too large to be represented within the physical confines of a child (or parent) window, and so scroll bars can be used to move (i.e., pan) the file within the confines of the window's boundaries. Horizontal scroll-bar 106 and vertical scroll-bar 107 are shown associated with document window 103a. Graphic window 103b is depicted only with horizontal scroll bar 108, while chart window 103c is shown without any scroll bars; in other words, the depicted chart file is of a small enough size to be shown completely within the confines of window 103c without the need of any scroll bars. Scroll bars can be dynamically created when a previously-small document gets so large that it more than fills the window (such as when the user is writing a letter).

Scroll buttons, such as those indicated by reference numerals 109, 110, and 111 are often used to indicate the relative placement of a document within the confines of the particular document window. For example, a document whose upper left-hand corner is displayed within a document might have a scroll button as the left-most portion of its horizontal scroll-bar, and a scroll button at the upper-most portion of its vertical scroll-bar (as shown with respect to window 103a).

The scroll bars are manipulated by the use of visual pointer 112 displayed via monitor 102, which is controlled by a hardware pointing-device, such as a mouse. In FIG. 1, visual pointer 112 takes the form of an arrowhead. Users generally interact the scroll bars according to one of three methods: by clicking on one of the arrow (triangle) icons at either end of the scroll bar (that is, the left and right arrows of a horizontal scroll-bar, or the up and down arrows of a vertical scroll-bar); by clicking in the area between an arrow icon and a scroll button; or by dragging a scroll button (sometimes referred to as an “elevator” towards one of its associated arrow icons.

Besides scrolling, there are other GUI operations that might be applied to windows. Two common, window operations are known as minimizing and maximizing. Generally, a window can be in one of three forms:—“minimized”, “maximized”, or “restored”. A parent window is maximized when it fully occupies the display area available to the application (usually the fall screen on video monitor 102, less the area that is reserved for interfacing with the operating system). A child window is maximized when it fully occupies the display area available in its current window. When a window is minimized, it disappears or is reduced to a small icon representation or title bar, so that it no longer is present to receive user inputs. In the case of a minimized parent window, the application is not actually terminated, but is running in the background. Similarly, in the case of a minimized child window, the document is not actually closed, but is simply set aside. The window is in the restored form when its size is somewhere between the minimize and maximize form. In FIG. 1, parent window 101 is maximized, and child windows 103a, 103b, and 103c are restored. These latter three windows can be maximized or minimized using buttons provided in the upper right-hand corner of each window or column respectively. Similar window control buttons are provided for parent window 101.

Windows (parent or children) can be moved within the available display area if they are in a restored state, typically by placing graphical pointer 112 on the window's title bar and then “dragging” the title bar to another location. Also, windows can usually be resized, typically by placing graphical pointer 112 on the edge or one of the corners of the window and then dragging the edge or corner to another location.

The electronic documents depicted in child windows 103a, 103b, and 103c can reside locally on a storage device that is physically integrated in the computer, or they can be provided via transmission across a computer network.

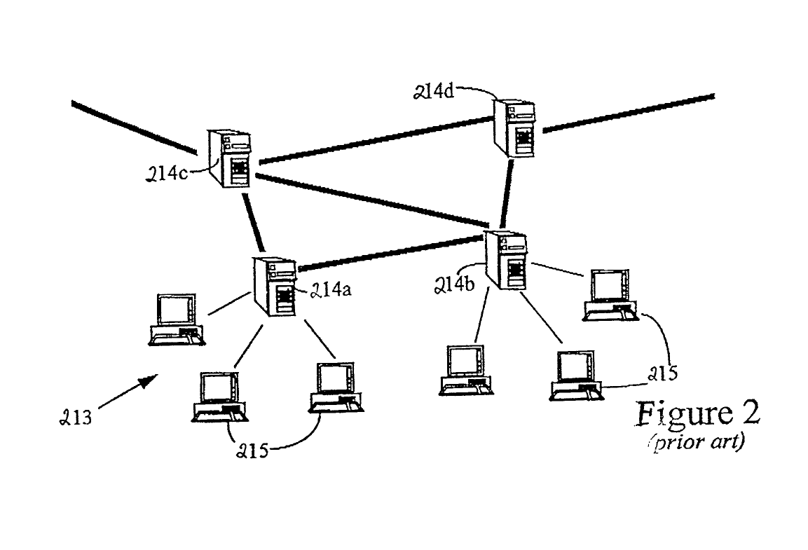

Referring to FIG. 2, a generalized client-server computing network 213 is depicted. Network 213 has several nodes or servers 214a, 214b, 214c, and 214d that are interconnected either directly to each other or indirectly through one of the other servers. Each server is essentially a stand-alone computer system (having one or more processors, memory devices, and communications devices), but has been adapted or programmed for one primary purpose: providing information to individual users at another set of nodes, or computer workstations, also known as clients. An example of such clients is illustrated at reference numeral 215. A client is a member of a class or group of computers that uses the services of another class or group to which it is not related. Clients 215 can be stand-alone computer systems (such as personal computers or PCs), or non-programmable systems adapted for limited use with network 213 (e.g., network computers, or NCs). A single, physical computer can act as both a client and a server, although this implementation occurs infrequently. A network can be local in nature, or can be further connected to other systems (not shown) as indicated with servers 214c and 214d.

The construction of network 213 is also generally applicable to the Internet. Conventional protocols and services have been established for the Internet that allow the transfer of various types of information, including electronic mail, simple file transfers via FTP (file transfer protocol) remote computing via Telnet, searching usenet news-groups, and hypertext file-delivery and multimedia streaming via the World Wide Web (WWW). A given server can be dedicated to performing one of these operations or running multiple services. Internet services are typically accessed by specifying a unique address, or Uniform Resource Locator (URL). The URL has two basic components: the protocol to be used and the target pathname. For example, the URL “http://www.uspto.gov” (home page for the United States Patent & Trademark Office on the WWW) specifies a hypertext transfer protocol (“http”) and the pathname of the server (“www.uspto.gov”). The server name is associated with a unique, numeric value, which can be in the form of a TCP/IP address (Transmission Control Protocol/Internet Protocol).

World Wide Web files (also called “documents” or “pages”) are interrelated by providing hypertext links in each one of the files; closely interrelated pages are commonly referred to as “web sites”. A hypertext link is an image that is viewable on the client's display and can be selected by the user using the mouse (or via a keyboard command), and which then automatically instructs client work station 215 to request another page associated with a selected hypertext link (i.e., issue another URL). A hypertext link can appear as a picture or image, or as a word or sentence, possibly underlined or otherwise accentuated to indicate that it is a link and not just normal, informative text or graphics.

A WWW page can have text, graphic images, and even multimedia objects such as sound recordings or animated video clips. A hypertext page, if more than just text, is usually constructed by loading several separate files, e.g., the hypertext “main.html” might include a reference to a graphic image file “picture.gif” or to a sound file “beep.wav”. When client workstation 215 sends a request to a server for a page, the server first transmits, at least partially, the main hypertext file associated with the page, and then loads, either sequentially or simultaneously, the other files associated with the page. The given file can be transmitted as several separate pieces via TCP/IP protocol. The constructed page is then displayed on the workstation monitor. The page can be larger than the physical size of the monitor (i.e., larger than the software-programmed window provides for viewing the pages), and techniques such as scroll bars are used by the viewing software (the web browser) to view different portions of the page.

Web pages are created using field-based languages, such as the hypertext markup language (HTML). This language provides a protocol for transmitting formatted information and control tags used to construct the complete page that is ultimately displayed by the browser. Different fields within the main HTML file are defined to store the formatted information and control-code parameters, using tags. Tags not only mark elements, such as text and graphics, but can also be used to construct graphical user-interfaces within the web page (such as control buttons that are depressed by selecting them using the graphical pointer). In HTML, a tag is a pair of angle brackets, “< >”, which contain one or more letters and numbers between the angle brackets. One pair of angle brackets is often placed before an element and another pair placed after, to indicate where the element begins and ends. For example, the language “<B> TODAY ONLY </B>” uses the “B” tag to provide a boldface formatting code for the words “TODAY ONLY”.

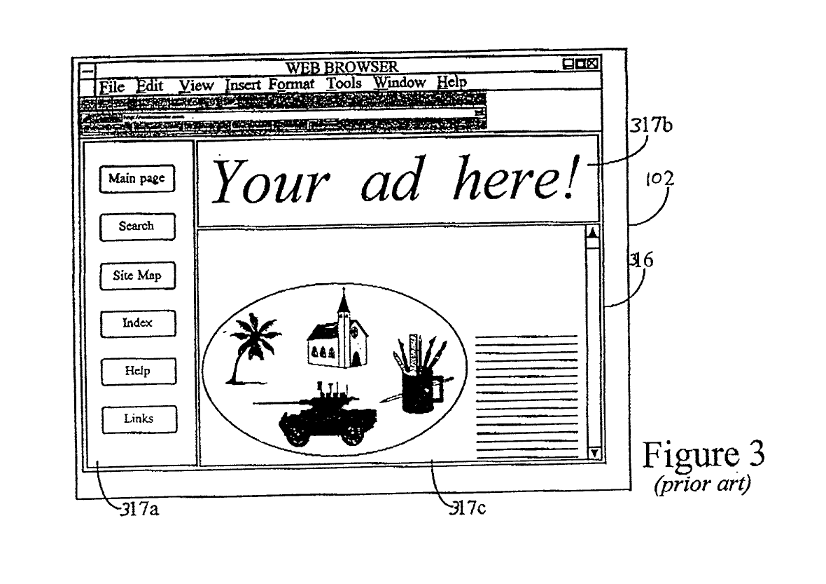

One innovation in browsers allows the simultaneous display of multiple fields or “frames” within a single, browser window, as illustrated in FIG. 3. Browser window 316 on computer display 102 contains three frames, 317a, 317b, and 317c, which divide the web page into multiple, scrollable regions. Frames can be created via HTML using the “FRAMESET” tag, which specifies exactly how the frames will appear on the web page, and the “FRAME” tag, which defines the various aspects of each frame, including which particular URL to load in the frame. The “COLS” and “ROWS” attributes placed within the FRAMESET tag dictate how the page is to be arranged. For example, the tag “<FRAMESET COLS='50%, 50% '>” divides the browser window vertically into two equal halves (one frame on the left and one frame on the right).

Frames are not child windows; that is, they are not necessarily resizable or otherwise controllable, since their attributes are fixed by the HTML coding. In the example of FIG. 3, the web page has been constructed to provide one frame (317a) with a few control buttons or hypertext links to other pages at the web site, another frame (317b) having an advertisement, and a third frame (317c) containing information that is of actual interest to the user. As a result, the viewable area assigned to frame 317c is small, making the content more difficult to read. This smaller presentation area can also make it difficult to scroll through the frame using the scroll button. These difficulties are exacerbated when the parent browser window uses less than the full display window (e.g., the browser is in a restored state). Additionally, the advertisement in frame 317b might be presented with automated blinking, scrolling, or highlighting, which is very distracting and can be particularly aggravating since that frame cannot be removed or reduced in size.

Detailed Description

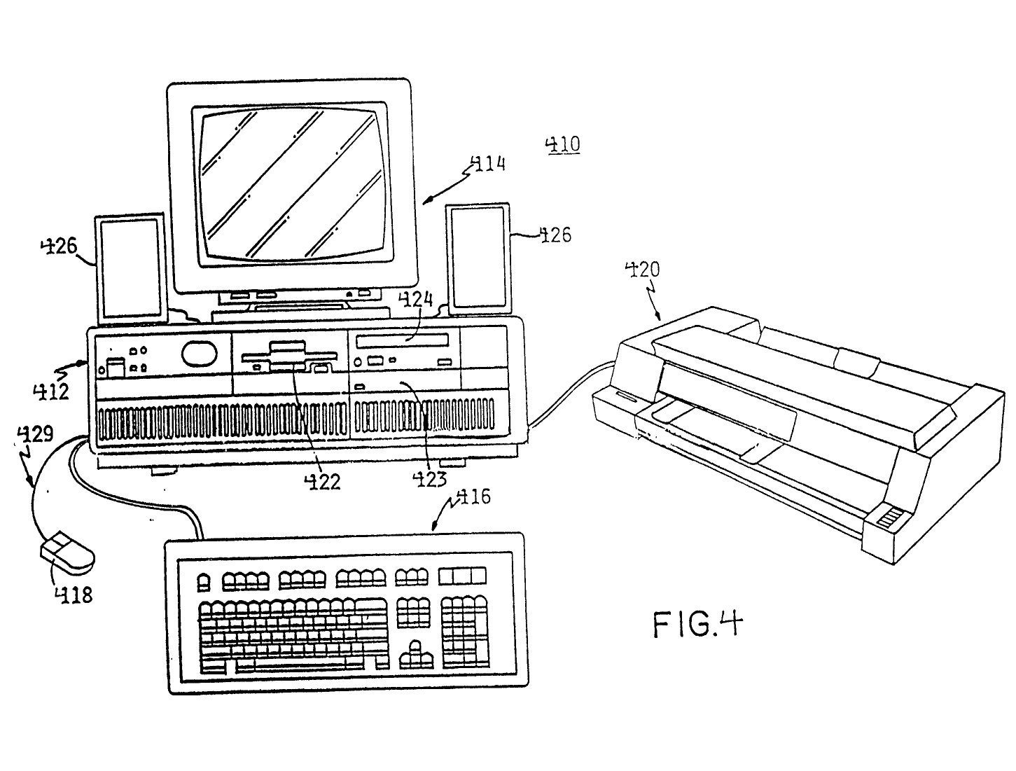

With reference now to the figures and in particular with reference to FIG. 4, there is depicted an embodiment of a computer system that can be utilized to implement the preferred embodiment. Computer system 410 includes processing unit 412, display device 414, keyboard 416, pointing device 418, printer 420, and speakers 426. Processing unit 412 receives input data from input devices such as keyboard 416, pointing device 418, and local area network interfaces (not illustrated) and presents output data to a user via display device 414, printer 420, and speakers 426. Pointing device 418 is preferably utilized in conjunction with a graphical user interface (GUI) in which hardware components and software objects are controlled through the selection and the manipulation of associated graphical objects displayed within display device 414. Although computer system 410 is illustrated with a mouse for pointing device 418, other graphical-pointing devices such as a graphic tablet, joystick, track ball, or track pad could also be utilized.

Keyboard 416 is that part of computer system 410 that resembles a typewriter keyboard and that enables a user to control particular aspects of the computer. Because information flows in one direction, from keyboard 414 to processing unit 412, keyboard 416 functions as an input-only device. Functionally, keyboard 416 represents half of a complete input/output device, the output half being video display terminal 414. Keyboard 416 includes a standard set of printable characters presented in a QWERTY pattern typical of most typewriters. In addition, keyboard 416 includes a calculator-like numeric keypad at one side. Some of these keys, such as the “control,” “alt,” and “shift” keys can be utilized to change the meaning of another key. Other special keys and combinations of keys can be utilized to control program operations or to move either text or cursor on the display screen of video display terminal 414.

Video-display terminal 414 is the visual output of computer system 410. As indicated herein, video-display terminal 414 can be a cathode-ray tube (CRT) based video display well-known in the art of computer hardware. But, with a portable or notebook-based computer, video display terminal 414 can be replaced with a liquid crystal display (LCD) based or gas, plasma-based, flat-panel display.

Pointing device 418 features a casing with a flat bottom that can be gripped by a human hand. Pointing device 418 can include buttons on the top, a multidirectional detection device such as a ball on the bottom, and a cable 429 that connects pointing device 418 to processing unit 412.

To support storage and retrieval of data, processing unit 412 further includes diskette drive 422, hard-disk drive 423, and CD-ROM drive 424, which are interconnected with other components of processing unit 412.

Computer system 410 can be implemented utilizing any suitable computer such as the IBM Aptiva computer, a product of International Business Machines Corporation, located in Armonk, N.Y. But, a preferred embodiment of the present invention can apply to any hardware configuration that allows browsing of documents, regardless of whether the computer system is a complicated, multi-user computing apparatus, a single-user workstation, or a network appliance that does not have non-volatile storage of its own.

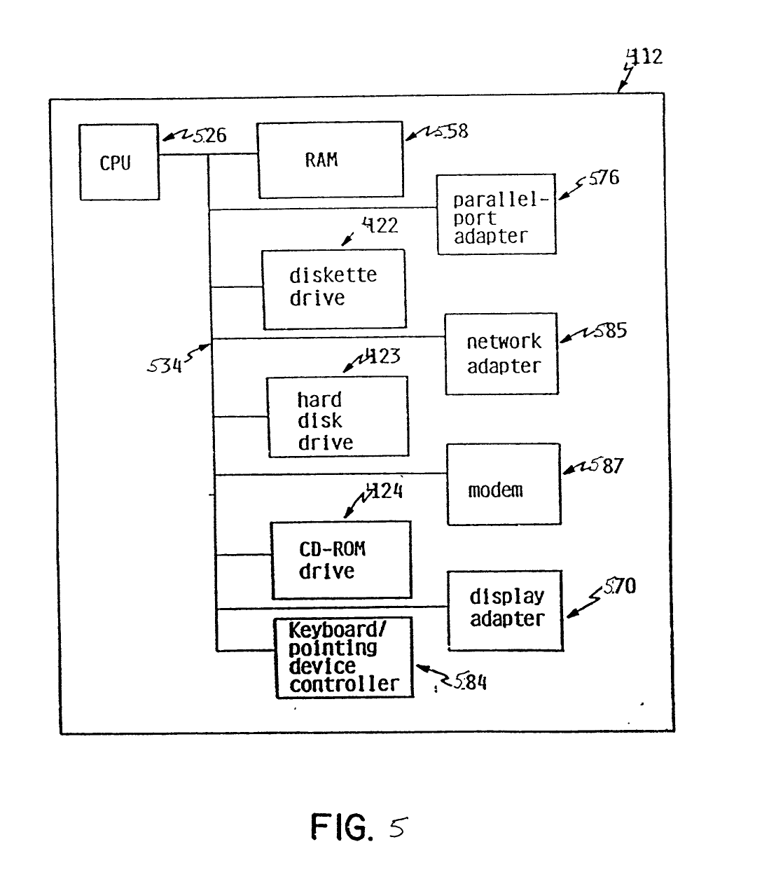

Referring to FIG. 5, there is depicted a block diagram of the principal components of processing unit 412. CPU 526 is connected via system bus 534 to RAM (Random Access Memory) 558, diskette drive 422, hard-disk drive 423, CD-ROM drive 424, keyboard/pointing-device controller 584, parallel-port adapter 576, network adapter 585, display adapter 570, and modem 587. Although the various components of FIG. 5 are drawn as single entities, each can consist of a plurality of entities and can exist at multiple levels.

Processing unit 412 includes central processing unit (CPU) 526, which executes instructions. CPU 526 includes the portion of computer system 410 that controls the operation of the entire computer system, including executing the arithmetical and logical functions contained in a particular computer program. Although not depicted in FIG. 5, CPU 526 typically includes a control unit that organizes data and program storage in a computer memory and transfers the data and other information between the various parts of the computer system. CPU 526 generally includes an arithmetic unit that executes the arithmetical and logical operations, such as addition, comparison, and multiplication. CPU 526 accesses data and instructions from and stores data to volatile RAM 558.

CPU 526 can be implemented as one of the 80X86 or Pentium processors, or any other type of processor, which are available from a number of vendors. Although computer system 410 is shown to contain only a single CPU and a single system bus, the present invention applies equally to computer systems that have multiple CPUs and to computer systems that have multiple buses that each perform different functions in different ways.

RAM 558 comprises a number of individual volatile memory modules that store segments of operating system and application software while power is supplied to computer system 410. The software segments are partitioned into one or more virtual memory pages that each contain a uniform number of virtual memory addresses. When the execution of software requires more pages of virtual memory than can be stored within RAM 558, pages that are not currently needed are swapped with the required pages, which are stored within non-volatile storage devices 422 or 423. RAM 558 is a type of memory designed such that the location of data stored in it is independent of the content. Also, any location in RAM 558 can be accessed directly without needing to start from the beginning.

Hard disk drive 423 and diskette drive 422 are electro-mechanical devices that read from and write to disks. The main components of a disk drive are a spindle on which the disk is mounted, a drive motor that spins the disk when the drive is in operation, one or more read/write heads that perform the actual reading and writing, a second motor that positions the read/write heads over the disk, and controller circuitry that synchronizes read/write activities and transfers information to and from computer system 410. A disk itself is typically a round, flat piece of flexible plastic (e.g., floppy disk) or inflexible metal (e.g. hard disk) coated with a magnetic material that can be electrically influenced to hold information recorded in digital form. A disk is, in most computers, the primary method for storing data on a permanent or semipermanent basis. Because the magnetic coating of the disk must be protected from damage and contamination, a floppy disk (e.g., 5.25 inch) or micro-floppy disk (e.g., 3.5 inch) is encased in a protective plastic jacket. But, any size of disk could be used. A hard disk, which is very finely machined, is typically enclosed in a rigid case and can be exposed only in a dust free environment.

Keyboard/pointing-device controller 584 interfaces processing unit 412 with keyboard 416 and graphical-pointing device 418. In an alternative embodiment, keyboard 416 and graphical-pointing device 418 have separate controllers.

Display adapter 570 translates graphics data from CPU 526 into video signals utilized to drive display device 414.

Finally, processing unit 412 includes network adapter 585, modem 587, and parallel-port adapter 576, which facilitate communication between computer system 410 and peripheral devices or other computer systems. Parallel-port adapter 576 transmits printer-control signals to printer 420 through a parallel port. Network adapter 585 connects computer system 410 to an unillustrated local area network (LAN). A LAN provides a user of computer system 410 with a means of electronically communicating information, including software, with a remote computer or a network logical-storage device. In addition, a LAN supports distributed processing, which enables computer system 410 to share a task with other computer systems linked to the LAN.

Modem 587 supports communication between computer system 410 and another computer system over a standard telephone line. Furthermore, through modem 587, computer system 410 can access other sources such as a server, an electronic bulletin board, and the Internet or World Wide Web.

The configuration depicted in FIG. 4 is but one possible implementation of the components depicted in FIG. 5. Portable computers, laptop computers, and network computers or Internet appliances are other possible configurations. The hardware depicted in FIG. 5 can vary for specific applications. For example, other peripheral devices such as optical-disk media, audio adapters, or chip-programming devices, such as PAL or EPROM programming devices well-known in the art of computer hardware, can be utilized in addition to or in place of the hardware already depicted.

As will be described in detail below, aspects of the preferred embodiment pertain to specific method steps implementable on computer systems. In an alternative embodiment, the invention can be implemented as a computer program-product for use with a computer system. The programs defining the functions of the preferred embodiment can be delivered to a computer via a variety of signal-bearing media, which include, but are not limited to, (a) information permanently stored on non-writable storage media (e.g., read only memory devices within a computer such as CD-ROM disks readable by CD-ROM drive 424); (b) alterable information stored on writable storage media (e.g., floppy disks within diskette drive 422 or hard-disk drive 423); or (c) information conveyed to a computer by a communications media, such as through a computer or telephone network, including wireless communications. Such signal-bearing media, when carrying computer-readable instructions that direct the functions of the present invention, represent alternative embodiments of the present invention.

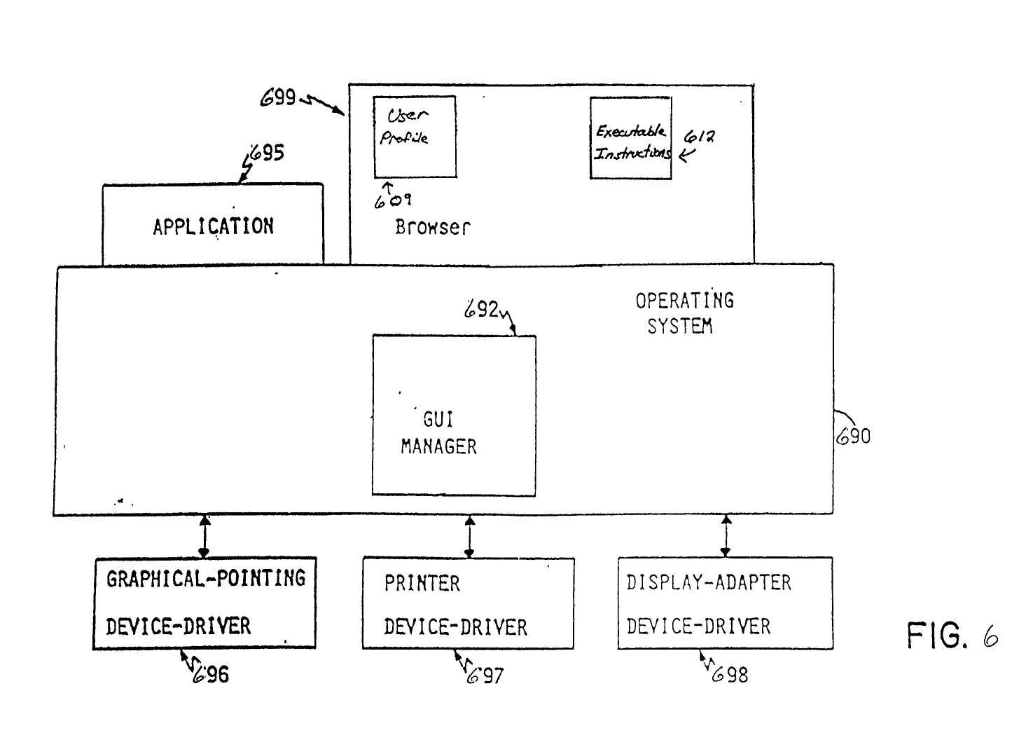

With reference now to FIG. 6, there is illustrated a block-diagram representation of the software configuration of computer system 410. As noted above, the software executed by computer system 410 can be stored within one or more of RAM 558, the nonvolatile storage provided by diskette drive 422, hard-disk drive 423, CD-ROM drive 424, or a remote server accessible via modem 587 or network adapter 585.

As illustrated, the software configuration of computer system 410 includes operating system 690, which is responsible for directing the operation of computer system 410. For example, operating systems typically include computer software for controlling the allocation and usage of hardware resources such as memory, CPU time, disk space, and peripheral devices. A suitable operating system 690 and associated graphical-user-interface manager 692 (e.g., Microsoft Windows, AIX, or OS/2 operating systems) could be used. Other technologies also could be utilized, such as touch-screen technology or human-voice control. The operating system is the foundation upon which applications 695 and 699 are built. Examples of applications are word-processing, spreadsheet, and web-browser programs.

In accordance with the preferred embodiment, operating system 690 includes graphical-user-interface (GUI) 692 manager although they could be packaged separately. GUI 692 manages the graphical-user-interface with which a user of computer system 410 interacts.

Operating system 690 communicates with application 695 and browser 699 through messages conforming to the syntax of the application-program-interface (API) supported by operating system 690. Operating system 690 further communicates with graphical-pointing device-driver 696, printer device-driver 697, and display-adapter device-driver 698. For example, operating system 690 sends graphics data to display-adapter device-driver 698, which in turn translates the messages into bus signals utilized to control display adapter 570. In addition, graphical-pointing device-driver 696 translates signals from pointing device 418 through keyboard/pointing-device controller 584 into Cartesian coordinates and a selection status, which are then relayed to GUI manager 692. Also, operating system 690 sends printer-control codes and data to printer device-driver 697, which in turn translates the control codes and data into bus signals used to control printer 420.

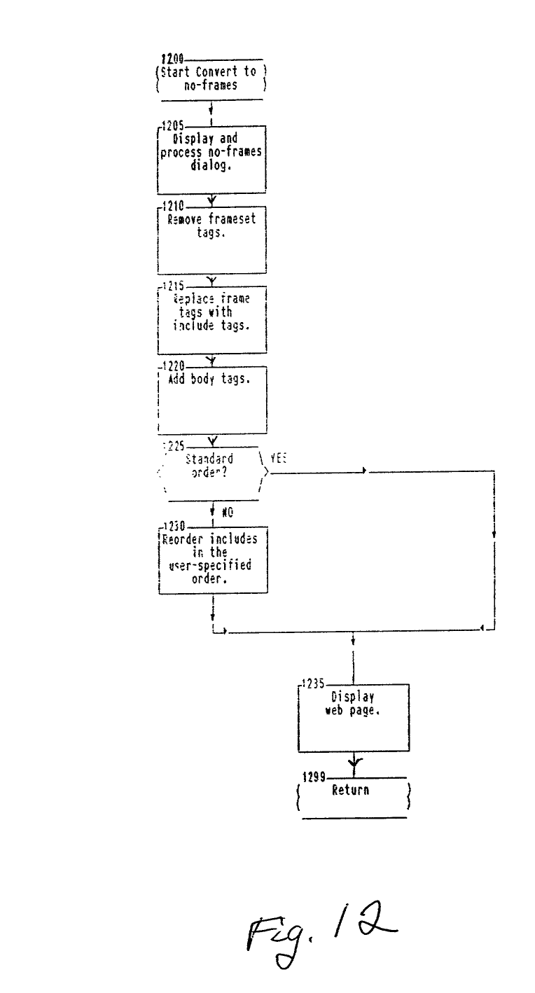

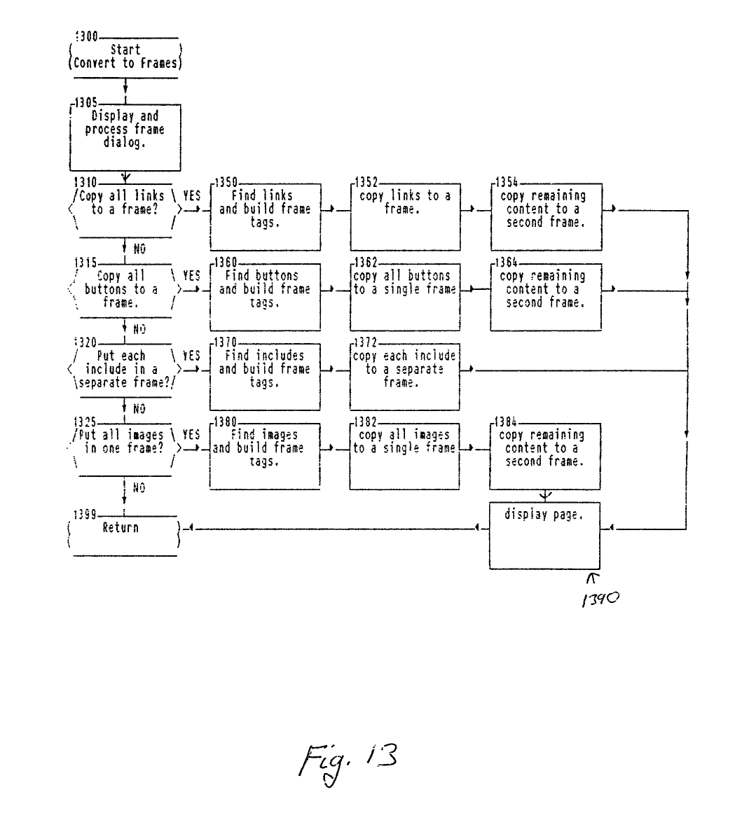

CPU 526 is suitably programmed to carry out the preferred embodiment by browser 699, as described in more detail in the flowcharts of FIGS. 12 and 13. In the alternative, the functions of FIGS. 12 and 13 could be implemented by control circuitry through the use of logic gates, programmable-logic devices, or other hardware components in lieu of a processor-based system.

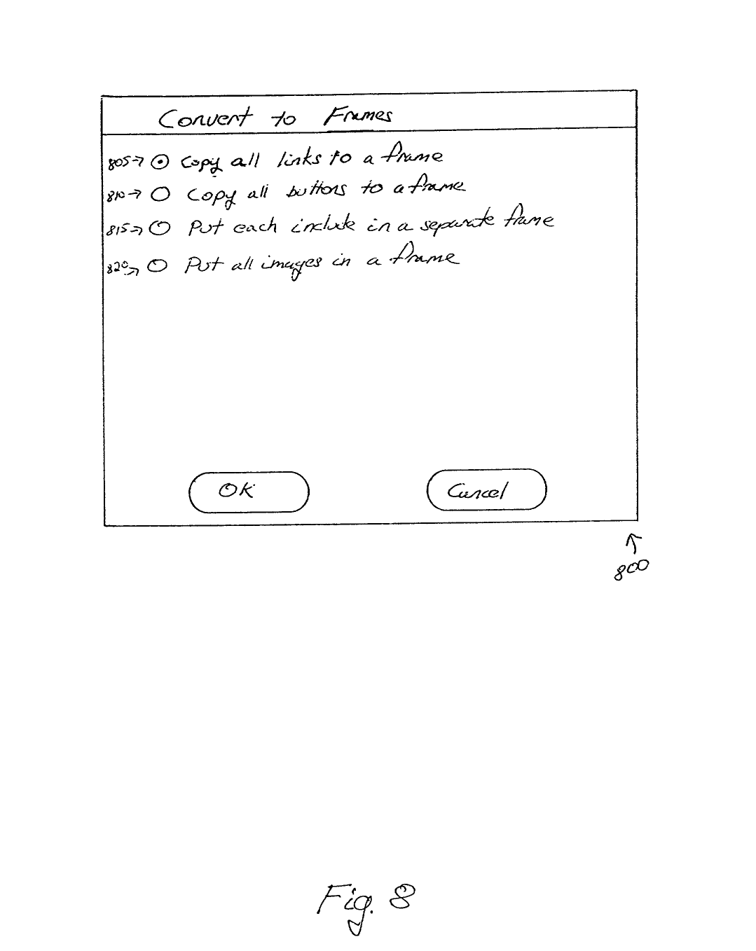

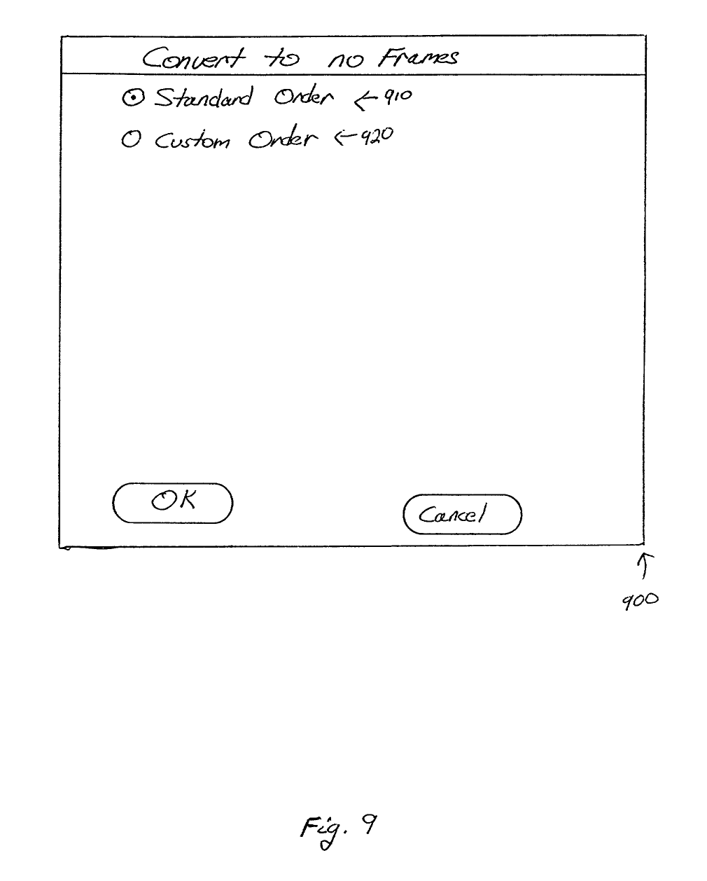

Browser 699 contains executable instructions 612 and user profile 609. Executable instructions 612 contains software instructions, which when executed by processor 526 carry out the functions of FIGS. 12 and 13. User profile 609 is a primary data structure of the preferred embodiment, and its contents are more fully described below under the description for FIGS. 8 and 9. Referring again to FIG. 6, although browser 699 is drawn as being separate from operating system 690, they could be packaged together.

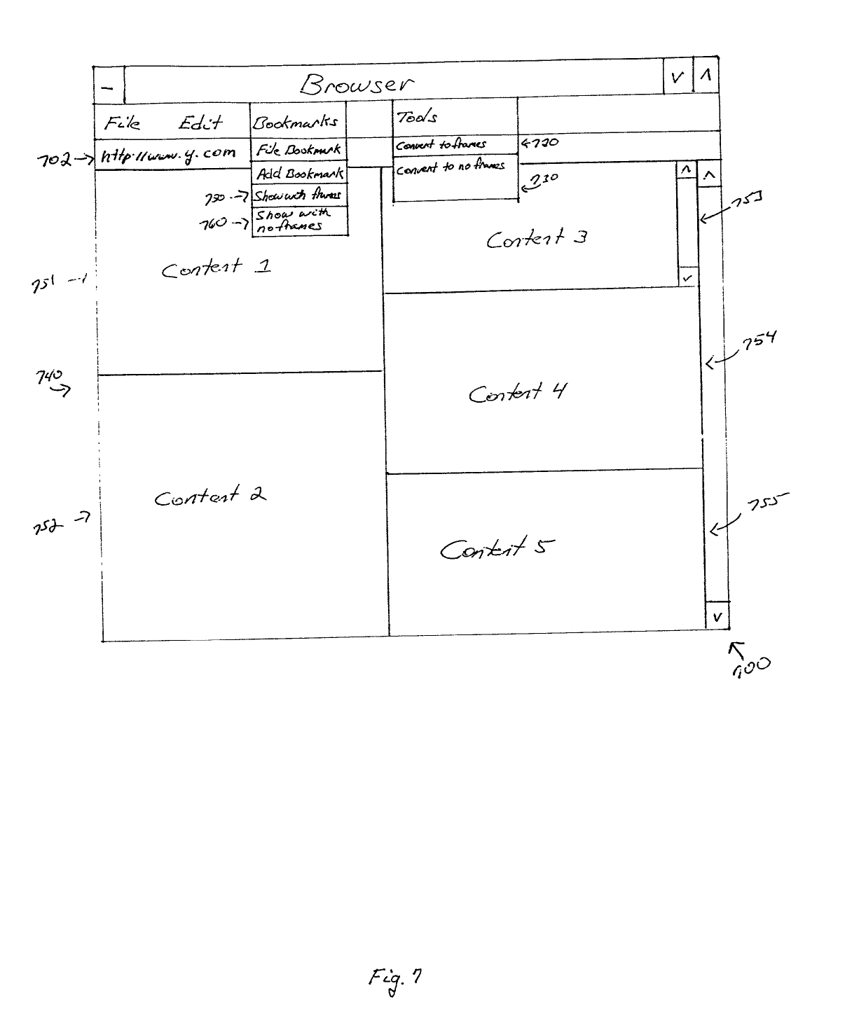

FIG. 7 illustrates a pictorial representation of the interfaces that are used to control the operations of the preferred embodiment. FIG. 7 contains browser window 700, which is displayed on display screen 414. Browser window 700 contains URL 702, which is the address from which browser 699 downloaded example page 740 from a server. In this example, URL 702 is the fictitious web site address “http://www.y.com”, and example page 740 contains frame 751, 752, 753, 754, and 755 with contents “content 1”, “content 2”, “content 3”, “content 4”, and “content 5”, respectively. The frames have fixed attributes, meaning that the position and dimensions of each frame are fixed within window 740. Thus, frames 751, 752, 753, 754, and 755 within browser window 740 are analogous to panes within a building window, and browser window 740 is said to have 5 window panes.

Referring again to FIG. 7, convert-to-frames button 720 gives the user the opportunity to specify that browser 699 should convert the contents of page 740 from no frames to frames. In the example shown in FIG. 7, convert-to-frames button 720 would be inapplicable because example page 740 already contains frames. The operation of browser 699 in response to convert-to-frames button 720 is further described below under the description for FIGS. 8, 10, and 13.

Referring again to FIG. 7, convert-to-no-frames button 730 gives the user the opportunity to specify that browser 699 should convert the contents of page 740 from frames to no frames, thus creating one window pane. The operation of browser 699 in response to convert-to-no-frames button 730 is further described below under the description for FIGS. 9, 10, and 12. Thus, convert-to-frames button 720 and convert-to-no-frames button 730 define reversible functions, and the user can switch back and forth between a page that contains frames and a page that does not contain frames.

Referring again to FIG. 7, show-with-frames bookmark button 750 gives the user the opportunity to specify that browser 699 should always display the specified page with frames whenever it is accessed via the bookmark list. Show-with-no-frames bookmark button 760 gives the user the opportunity to specify that browser 699 should always display the selected page without frames when the page is selected from the bookmark list. A bookmark list, also called a favorites list, is utilized by the user to save URLs of interest, so that the user can easily access them in the future.

FIG. 8 illustrates a pictorial representation of dialog 800 presented by browser 699 when the user selected convert-to-frames button 720, as shown in FIG. 7. Referring again to FIG. 8, dialog 800 contains copy-links button 805, copy-buttons button 810, include button 815, and image button 820. Copy-links button 805 directs browser 699 to search the web-page document for all control tags that contain a hyperlink and put all of these hyperlinks in one frame, as browser 699 converts the display of the web page from no-frames to frames. Copy-buttons button 810 directs browser 699 to search the web-page document for button control-tags and to copy all of these control tags to a single frame, as browser 699 converts the display of the displayed web-page from no-frames to frames. Include button 815 causes browser 699 to search the web-page document for include control-tags and put all of the include control-tags in one frame, as browser 699 converts the displayed web-page from no-frames to frames. Image button 820 causes browser 699 to search the displayed web-page document for image control-tags, and to put all of the found image control-tags in a single frame, as browser 699 converts the displayed web page from no-frames to frames. Browser 699 saves the user-selected options in user profile 609. Browser 699 processing in response to the user selection in FIG. 8 is further described below under the description for FIG. 13.

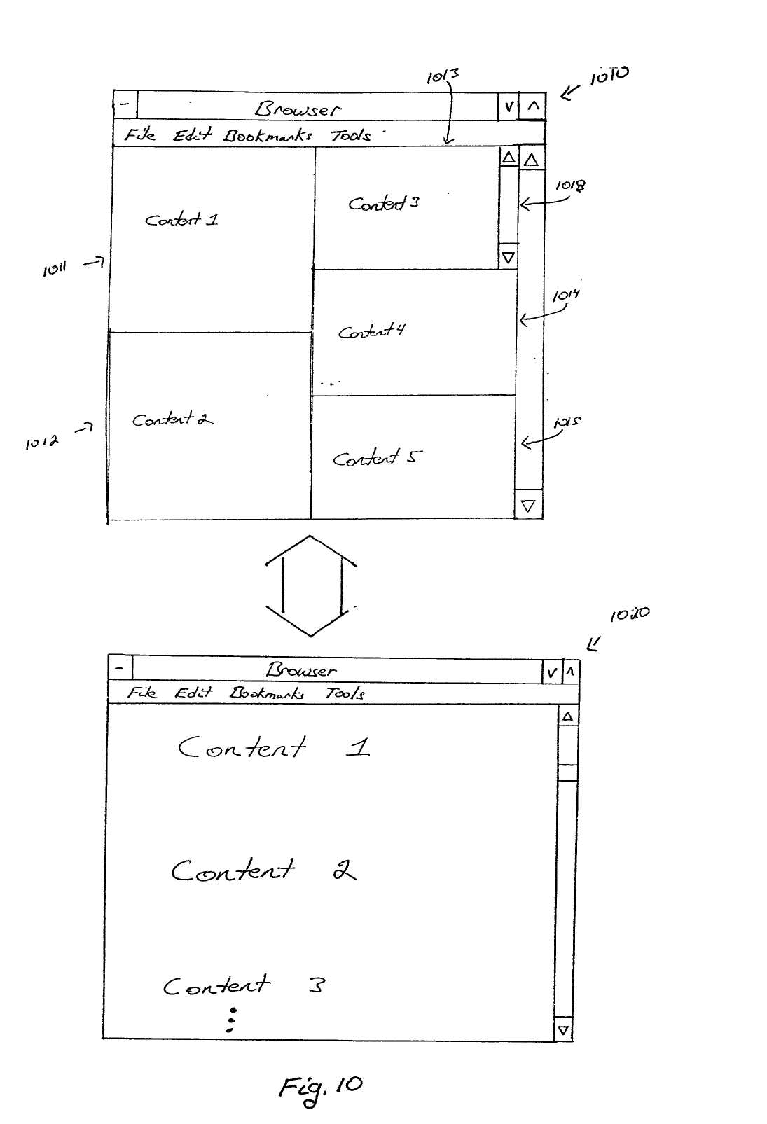

FIG. 9 illustrates a pictorial representation of dialog 900 presented by browser 699 when the user selected convert-to-no-frames button 730, as shown in FIG. 7. Referring again to FIG. 9, dialog 900 contains standard-order button 910 and custom-order button 920. When the user selects standard-order button 910, browser 699 converts the displayed web-page from frames to no-frames and orders the contents of the web-page document in the order that the contents are coded in the web-page document, as further described below under the description for FIGS. 10 and 12. When the user selects custom-order button 920, browser 699 reorders the contents of the frames in a user-specified order when the browser does the conversion from frames to no frames, as further described below under the description for FIG. 12. For example, the user could specify an order by clicking on each respective frame in the order that the user would like to see the frame contents displayed after browser 699 has converted the multiple frames to a single panel. Browser 699 records the order as the user selects each respective frame. Browser 699 saves the user-selected options in user profile 609.

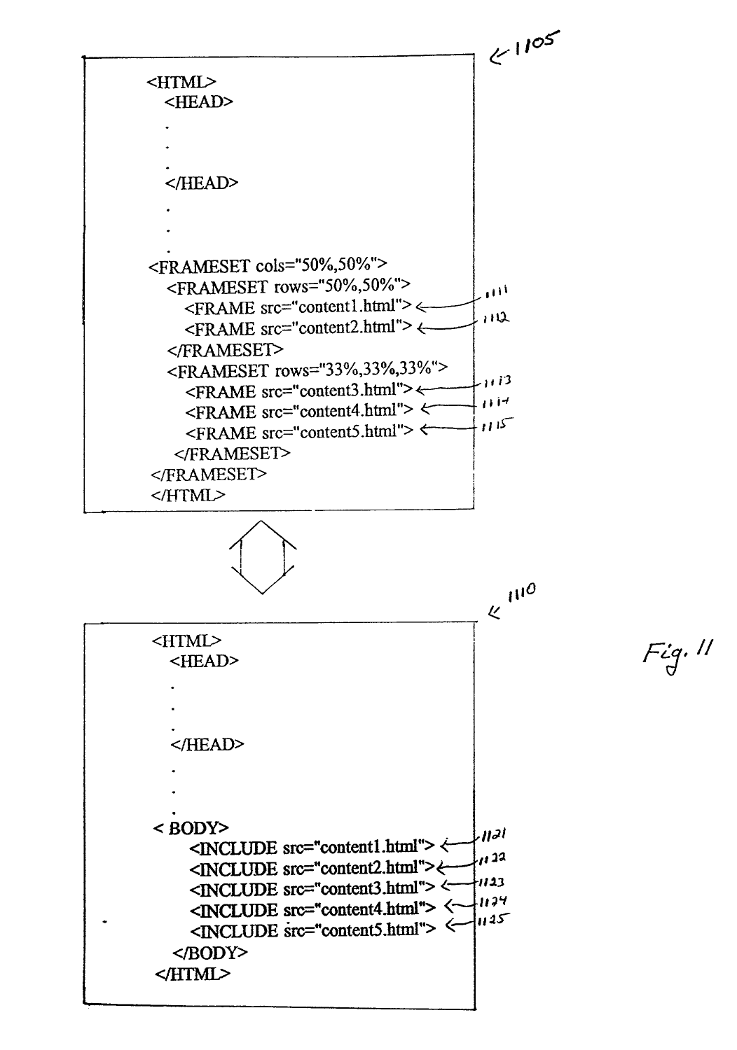

FIG. 10 illustrates a pictorial representation of an example operation of the preferred embodiment. Browser windows 1010 and 1020 are shown. Browser 699 transforms the web-page document control-tags between frame and non-frame control-tags and displays the result as window 1010 (frame control-tags) or window 1020 (non-frame control-tags). This transformation process is further described below under the description for FIGS. 12 and 13. The corresponding web-page documents for browser window 1010 and 1020 are further described below under the description for FIG. 11.

Referring again to FIG. 10, window 1010 contains five frames 1011, 1012, 1013, 1014, and 1015, having respective contents “content 1”, “content 2”, “content 3”, “content 4”, and “content 5”. Each frame in browser window 1010 is a pane. Frame 1013 contains its own scroll bar 1018, indicating that the entire contents of frame 1013 could not be displayed within the pane. Window 1020 contains the same contents as does window 1010, but in a single window pane without the frames. “Content 1”, “content 2”, “content 3” are shown in window 1020, but “content 4” and “content 5” are out of view in window 1020 because “content 3” consumes too much room (remember that frame 1013 in window 1010 contained scroll bar 1018 because “content 3” could not be fully displayed in frame 1013).

FIG. 11 is a pictorial representation of example contents of web-page documents, according to the preferred embodiment. FIG. 11 illustrates the web-page document transformation performed by browser 699. Web-page document 1105 contains frame control-tags while web-page document 1110 contains the same contents as web-page document 1005, but does not contain frame control-tags. Web-page document 1105 corresponds to browser window 1010 in FIG. 10 while web-page document 1110 corresponds to browser window 1020 in FIG. 10. Referring again to FIG. 11, browser 699 performs the transformation between web-page document 1105 and web-page document 1110, as further described below under the description for FIGS. 12 and 13. Frame tag 1111 corresponds to include tag 1121, frame tag 1112 corresponds to include tag 1122, frame tag 1113 corresponds to include tag 1123, frame tag 1114 corresponds to include tag 1124, and frame tag 1115 corresponds to include tag 1125. Notice that the include tags 1121, 1122, 1123, 1124, and 1125 are in the same order as frame tags 1111, 1112, 1113, 1114, 1115 because the user previously specified standard order 910 in FIG. 9.

FIGS. 12 and 13 are flowcharts that describe the operation of the preferred embodiment. Referring to FIG. 12, there is illustrated the logic of browser 699 that converts a web-page document that contains frames to a web-page document that does not contain frames. Browser 699 can either create a new document or convert the existing document in place. At block 1200, processing begins. Control then continues to block 1205 where browser 699 displays dialog 900, as shown in FIG. 9, to the user and processes the user's selection. Referring again to FIG. 12, control then continues to block 1210 where browser 699 deletes the “frameset” control-tags from the web-page document. Control then continues to block 1215 where browser 699 replaces the “frame” tags in the web-page document with “include” tags, as previously described above under the description for FIG. 11. Referring again to FIG. 12, control then continues to block 1220 where browser 699 adds “body” tags to the web-page document, as previously described above under the description for FIG. 11. Referring again to FIG. 12, control then continues to block 1225 where browser 699 determines whether the user selected standard-order button 910, as previously described above under the description for FIG. 9. Standard order means that the user wants to see the contents in the order that they are coded in the web-page document. FIG. 11 shows an example of a standard-order transformation. Referring again to FIG. 12, if the determination at block 1225 is true, then control continues to block 1235 where browser 699 displays the transformed web-page. The function then ends at block 1299.

If the determination at block 1225 is false, then control continues to block 1230 where browser 699 reorders the “include” statements to be in the user-specified order. Re-ordering the “include” statements will change the order that the contents are displayed on the display screen when the web page is displayed. Control then continues to block 1235, as previously described above.

Referring to FIG. 13, there is illustrated sample logic for browser 699 that converts a web-page document from no-frames to frames, in response to the user selecting convert-to-frames button 720 or show-with-frames button 750, as previously described above under the description for FIG. 7. Browser 699 can either create a new document or convert the existing document in place. Referring again to FIG. 13, at block 1300, browser 699 starts. Control then continues to block 1305 where browser 699 displays and processes dialog 800, as previously described above under the description for FIG. 8. Referring again to FIG. 13, control then continues to block 1310 where browser 699 determines whether the user has specified copy-link button 805. If the determination at block 1310 is true, then control continues to block 1350 where browser 699 finds all of the link control-tags in the web-page document and builds frame tags for the web-page document. Control then continues to block 1352 where browser 699 copies all of the found links to one frame. Control then continues to block 1354 where browser 699 copies the remaining content of the web-page document to a second frame. Control then continues to block 1390 where browser 699 displays the newly constructed web-page that contains frames. Control then continues to block 1399 where the function stops.

If the determination at block 1310 is false, then control continues to block 1315 where browser 699 determines whether the user has previously selected copy-buttons button 810, as previously described above under the description for FIG. 8. Referring again to FIG. 13, if the determination at block 1315 is true, then control continues to block 1360 where browser 699 finds all of the button control-tags in the web-page document and builds frame tags for the web-page document. Control then continues to block 1362 where browser 699 copies all of the found buttons to one frame. Control then continues to block 1364 where browser 699 copies the remaining content of the web page to a second frame. Control then continues to block 1390, as previously described above.

If the determination at block 1315 is false, then control continues to block 1320 where browser 699 determines whether the user has previously selected include button 815, as previously described above under the description for FIG. 8. Referring again to FIG. 13, if the determination at block 1320 is true, then control continues to block 1370 where browser 699 finds all of the include control-tags in the web-page document and builds frame tags for the web-page document. Control then continues to block 1372 where browser 699 copies each include to a separate frame. Control then continues to block 1390, as previously described above.

If the determination at block 1320 is false, then control continues to block 1325 where browser 699 determines whether the user has specified image button 1820, as previously described above under the description for FIG. 8. Referring again to FIG. 13, if the determination at block 1325 is true, then control continues to block 1380 where browser 699 finds all of the image control-tags in the web-page document and builds frame tags for the web-page document. Control then continues to block 1382 where browser 699 copies all of the images to one frame. Control then continues to block 1384 where browser 699 copies the remaining content of the web-page document to a second frame. Control then continues to block 1390, as previously described above.

While this invention has been described with respect to the preferred and alternative embodiments, it will be understood by those skilled in the art that various changes in detail can be made therein without departing from the spirit, scope, and teaching of the invention. For example, browsers may become widely employed in consumer applications such as operator panels for consumer electronics, appliances, and automobiles. Accordingly, the herein disclosed invention is to be limited only as specified in the following claims.

What is claimed is:

1. A method for browsing a displayable page, comprising:
determining that the page is adapted to be displayed in a first window containing a plurality of panes having fixed attributes;
transforming the plurality of panes to a single pane; and
displaying the single pane in a second window.

2. The method of claim 1, wherein the first window and the second window are different windows.

3. The method of claim 1, wherein the first window and the second window are the same window.

4. The method of claim 1, wherein the page comprises a plurality of control tags and data, and wherein the displaying step further comprises interpreting the control tags to format the data in the single pane.

5. The method of claim 1, wherein the transforming step further comprises removing frame control-tags from the page.

6. The method of claim 1, wherein the transforming step further comprises adding a body control-tag to the page.

7. The method of claim 1, wherein the transforming step further comprises reordering the content of the page.

8. The method of claim 1, further comprising:
reversing the transforming step to create a second plurality of panes from the single pane.

9. The method of claim 8, wherein the reversing step further comprises
copying all links to a first frame.

10. The method of claim 8, wherein the reversing step further comprises:
copying all buttons to a single frame.

11. The method of claim 8, wherein the reversing step further comprises:
copying each include to a separate frame.

12. The method of claim 8, wherein the reversing step further comprises:
copying all images to a single frame.

13. An apparatus that browses a displayable page, comprising:
a processor;
memory coupled to the processor; and
a browser residing in the memory and executing on the processor, wherein the browser determines that the page is adapted to be displayed in a first window containing a plurality of panes having fixed attributes, transforms the plurality of panes to a single pane, and displays the single pane in a second window.

14. The apparatus of claim 13, wherein the first window and the second window are different windows.

15. The apparatus of claim 13, wherein the first window and the second window are the same window.

16. The apparatus of claim 13, wherein the page comprises a plurality of control tags and data, and wherein the browser step further interprets the control tags to format the data in the single pane.

17. The apparatus of claim 13, wherein the browser further removes frame control-tags from the page.

18. The apparatus of claim 13, wherein the browser further adds a body control-tag to the page.

19. The apparatus of claim 13, wherein the browser further reorders the content of the page.

20. The apparatus of claim 13, wherein the browser further creates a second plurality of panes from the single pane.

21. The apparatus of claim 20, wherein the browser further copies all links to a first frame.

22. The apparatus of claim 20, wherein the browser further copies all buttons to a single frame.

23. The apparatus of claim 20, wherein the browser further copies each include to a separate frame.

24. The apparatus of claim 20, wherein the browser further copies all images to a single frame.

25. A program product that browses a displayable page, comprising:
a browser that determines that the page is adapted to be displayed in a first window containing a plurality of panes having fixed attributes, transforms the plurality of panes to a single pane, and displays the single pane in a second window; and
signal-bearing media bearing the browser.

26. The program product of claim 25, wherein the first window and the second window are different windows.

27. The program product of claim 25, wherein the first window and the second window are the same window.

28. The program product of claim 25, wherein the page comprises a plurality of control tags and data, and wherein the browser step further interprets the control tags to format the data in the single pane.

29. The program product of claim 25, wherein the browser further removes frame control-tags from the page.

30. The program product of claim 25, wherein the browser further adds a body control-tag to the page.

31. The program product of claim 25, wherein the browser further reorders the content of the page.

32. The program product of claim 25, wherein the browser further creates a second plurality of panes from the single pane.

33. The program product of claim 32, wherein the browser further copies all links to a first frame.

34. The program product of claim 32, wherein the browser further copies all buttons to a single frame.

35. The program product of claim 32, wherein the browser further copies each include to a separate frame.

36. The program product of claim 32, wherein the browser further copies all images to a single frame.
